(19) United States
(12) Patent Application Publication
(10) Pub. No.: US 2014/0251230 A1
(43) Pub. Date: Sep. 11, 2014

(54) FELINE GROOMING MODALITY

(71) Applicant: Eileen Go, Alameda, CA (US)

(72) Inventor: Eileen Go, Alameda, CA (US)

(21) Appl. No.: 14/199,888

(22) Filed: Mar. 6, 2014

Related U.S. Application Data
(60) Provisional application No. 61/774,954, filed on Mar. 8, 2013.

(51) Int. Cl. A01K 13/00; A01K 15/02

(52) U.S. Cl. CPC A01K 13/004; A01K 15/024
USPC 119/706

(57) ABSTRACT

A grooming and scratching device for felines that can be selectively anchored under a door and stored away when desired.

### CLAIM OF PRIORITY

The following application claims priority to U.S. Provisional Patent Application No. 61/774,954, filed Mar. 8, 2013, the complete contents of which are hereby incorporated by reference.

### FIELD OF THE INVENTION

The present device relates to the field of pet care products, particularly grooming & entertainment devices for felines.

### BACKGROUND

Felines have a natural tendency to frequently groom themselves, including rubbing their head, face, neck, and chin areas, in which they have sebaceous scent glands. Rubbing these areas not only relieves any itching, but allows cats to mark their territory by scent. In addition, some cats also have narrow Eustachian tubes, which can cause itching around their ears and cheeks. To relieve itching in these areas, cats usually prefer to rub against something, since they could injure themselves in sensitive facial areas while using their sharp claws. Moreover, cats regularly scratch surfaces around them as a method of communication and a way to sharpen their claws.

While walking around, cats often rub against walls, corners, or doors, and often scratch carpets, furniture, or other undesirable surfaces. Some devices exist that can be affixed to various surface to provide a more pleasant and effective rubbing experience for a cat. However, these devices usually must be affixed using adhesive or other types of fasteners, which can damage the walls, doors, furniture, or other surfaces. In addition, the device cannot be conveniently stored, if needed. Moreover, cat scratching posts and trees can often be large and an eyesore, and aren't easily stored when desired.

What is needed is a simple and portable device to provide suitable facial and body rubbing for cats to groom themselves and/or a proper area and material for scratching.

### SUMMARY

The present device provides a substantially vertical textured surface against which cats can rub their heads, necks, and faces and/or scratch with their claws. The device can be portable and stores easily since it does not need to be affixed to a wall or other vertical surface for support, but instead anchors under a door.

### BRIEF DESCRIPTION OF THE DRAWINGS

Further details of the present device are explained with the help of the attached drawings in which:

FIG. 1 depicts a perspective view of the present device.

FIG. 2 depicts a side view of another embodiment of the present device.

FIG. 3 depicts a perspective view of yet an alternate embodiment of the present device.

FIG. 4A depicts a planar view of the anterior side of the present device.

FIG. 4B depicts a planar view of an alternate embodiment of the anterior side of the present device.

### DETAILED DESCRIPTION

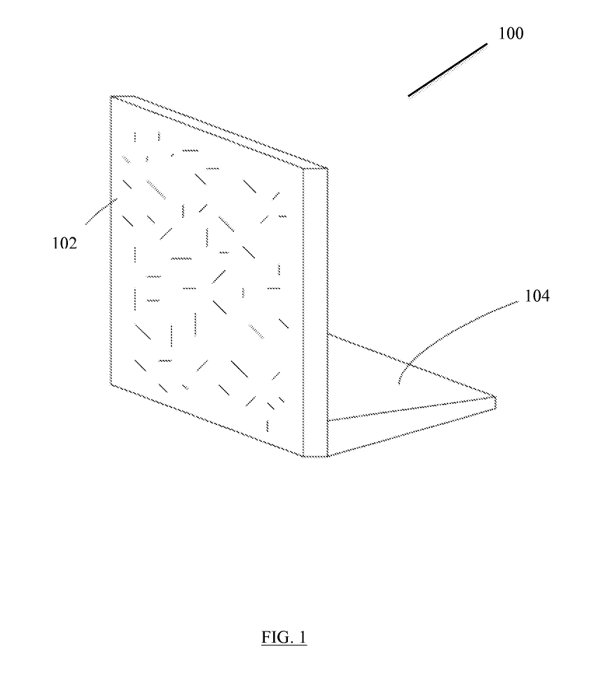

As shown in FIG. 1, a device 100 can be comprised of at least one substantially planar member 102 and at least one base member 104. In some embodiments, at least one substantially planar member 102 can have a substantially rectangular geometry, as depicted in FIG. 1. In other embodiments a substantially planar member 102 can be a square, circle, triangle, or a desired novelty shape such as a paw or a mouse. In alternate embodiments, a substantially planar member 102 can have any other known and/or convenient geometry. Moreover, a substantially planar member 102 can have any desired thickness or overall size.

A substantially planar member 102 can be comprised of metal, wood, plastic, polymer, silicone, fabric, and/or any other known and/or convenient material or combination of materials. In some embodiments, a substantially planar member 102 can have a graphic image or pattern printed on one or more of its surfaces. A graphic image or pattern can be for novelty purposes or to attract a feline to the device 100 or assist the feline in distinguishing the device 100 from the door with which it is being used. Moreover, a substantially planar member 102 can have any desired color, sheen, or combination of colors or sheens. In some embodiments, at least one surface of a substantially planar member 102 can have anti-bacterial, anti-fungal, anti-mold, and/or ultraviolet radiation-protective coating or inherent properties. In some embodiments, a substantially planar member 102 and/or the entire device 100 can be easily washable by hand and/or dishwasher.

A substantially planar member 102 can have a posterior surface and an anterior surface and can be positioned in a vertical configuration in use. The posterior surface of a substantially planar member 102 can face the surface of a door when in use, while the anterior surface of a substantially planar member 102 can face outwards for use by a feline. Moreover, a base member 104 can have a distal end and a proximal end. Referring to FIG. 1, in some embodiments the distal end of a base member 104 can be coupled with the lower portion of the posterior surface of said substantially planar member, such that the base member 104 can extend substantially perpendicular from the posterior surface of and vertically support said substantially planar member. As shown, a base member 104 can have a wedge configuration, with the larger, thicker, proximal end being configured proximate to the posterior surface of a substantially planar member 102. In some embodiments, a base member 104 can be located on at least one lateral vertical edge of a substantially planar member 102, and can extend substantially perpendicular to the posterior surface of a substantially planar member 102 to hold a substantially planar member 102 vertically. However, in other embodiments, at least one base member 104 can be located at any known and/or convenient location on the posterior surface of a substantially planar member 102.

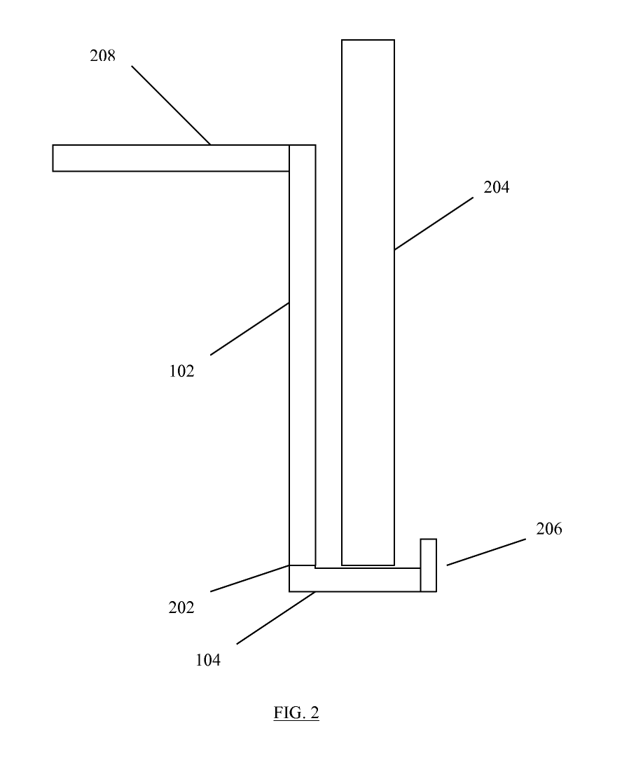

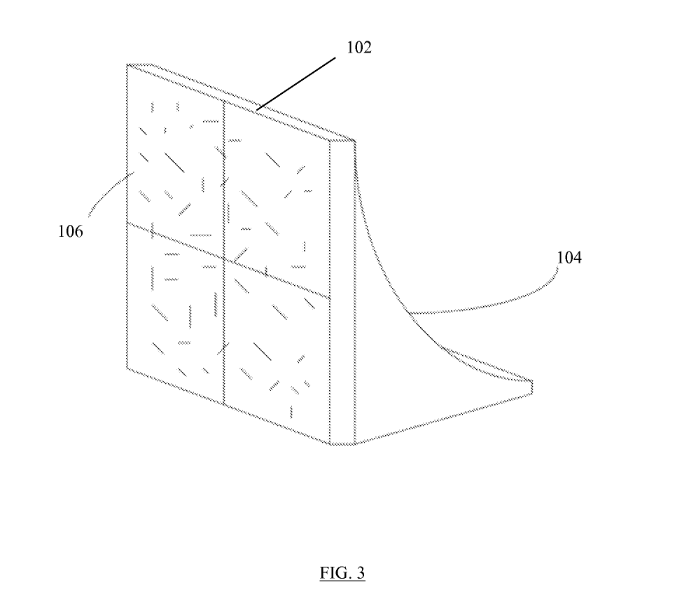

In the embodiment shown in FIG. 1, a base member 102 can have a substantially triangular geometry, but in other embodiments can have a cuboid geometry (see FIG. 2), a tapered and/or curved surface (see FIG. 3), or any other known and/or convenient geometry. In some embodiments, a base member 102 can have dimensions such that when positioned under a door, the top surface of a base member 102 can contact the bottom edge of a door at a point located between the posterior surface of a substantially planar member 102 and the midpoint of the top surface of a base member 104. However, in other embodiments, a base member can have any other known and/or convenient dimensions that can allow it to fit within the vertical space between the bottom of a door and a floor. Moreover, in some embodiments, a device 100 can comprise two or more base members 104 coupled with one or more surfaces of a substantially planar member 102.

In some embodiments, a base member 104 can be coupled with a substantially planar member 102 via one or more screws, rivets, friction pins, adhesive, pivoting connectors, tongue-and-groove joints, or any other known and/or convenient fastener. Moreover, in some embodiments, at least one base member 104 and at least one substantially planar member 102 can be thermally bonded or welded together, or they can be injection molded as once piece. In some embodiments, at least one base member 104 can be coupled with the posterior surface of a substantially planar member 102, whereas in other embodiments a base member 104 can be coupled with any perimeter edge and/or the anterior surface of a substantially planar member 102. FIGS. 1-2 depict embodiments of a device 100 wherein a substantially planar member 102 and a base member 104 are separate components that are coupled together in a desired manner, as described above. However in additional embodiments, a substantially planar member 102 and one or more base members 104 can be one continuous piece of material. In still further embodiments, at least one base member 104 can be selectively removable from a device 100.

A base member 104 can be made of polymer, wood, metal, or any other known and/or convenient material. In some embodiments, a base member 104 can be made of a material having a sufficient coefficient of friction in relation to a flooring surface and/or the bottom edge of a door to resist motion. In other embodiments, an additional layer of material can be placed on the top and/or bottom surface of a base member 102 to increase frictional forces. In yet further embodiments, a bumpy, ridged, or other textured surface on a base member 104 can be utilized to achieve desired anti-skid properties. Moreover, a base member 104 can have any desired color, sheen, or combination of colors or sheens. In some embodiments, a base member 104 can have anti-bacterial, anti-fungal, anti-mold, and/or ultraviolet radiation-protective coating or inherent properties. In some embodiments, a substantially planar member 102 and/or the entire device 100 can be easily washable by hand and/or dishwasher.

Referring to FIG. 2, in some embodiments, a hinge mechanism 202 can be used to couple the lower portion of the posterior surface of a substantially planar member 102 with a base member 104. A hinge mechanism 202 can enable folding of a device 100 to a lower profile such that it can be conveniently stored away in a closet, under a bed, or in any other desired location when not in use. Furthermore, a base member 104 can be at least as long as the width of a door 204. In some embodiments, the proximal end of a base member 104 can extend past the posterior side of a door 204 for increased stability. In yet further embodiments, the proximal end of a base member 104 can further comprise an anchoring mechanism 206 that can be selectively employed to provide additional stability to a device 100 when in use, and/or minimize movement or sliding of a device 100.

In the embodiments depicted in FIGS. 1-2, at least one base member 104 can be utilized as a doorstop to hold a door open or in a desired position. In embodiments where at least one base member 104 is selectively detachable, a base member 104 can be used as a doorstop without the remainder of the device 100. In other embodiments, the entire device 100 can be used as a doorstop.

Referring to FIGS. 1 and 3, at least a portion of the anterior surface of a substantially planar member 102 can be a textured surface 106. A textured surface 106 can comprise ridges, grooves, nubs, gritty texture, brush-like extensions, or any other known and/or convenient surface characteristic that can provide a pleasing sensation to a cat. Moreover, an anterior surface, perimeter edges, and/or a posterior surface can have material suited for cat scratching, such as carpet, sisal, cardboard, or any other known and/or convenient material for feline scratching. As shown in FIG. 1, a textured surface 106 can be uniform for substantially the entirety of the anterior surface of a planar member 102, but in other embodiments, as shown in FIG. 3, can be comprised of regions of varying textures.

In some embodiments, a textured surface 106 can be comprised of plastic, fabric, silicone, nylon, mesh, and/or polymer, but in other embodiments can be comprised of any other known and/or convenient material. In some embodiments, a textured surface 106 can be removably affixed to the anterior surface of a substantially planar member 102 via hook-and-loop, snaps, buttons, or any other known and/or convenient attachment device. In such embodiments, a textured surface 106 can be removed and washed and/or replaced.

Referring to FIG. 2, a device 100 can further comprise a perch 208. A perch 208 can be a horizontally configured substantially planar component that can be coupled with the top edge of a substantially planar member 102. A perch 208 can be made of wood, plastic, polymer, or any other desired material or combination of materials, and can have any desired color, geometry, and/or texture. In use, a cat can use a perch 208 for rubbing, scratching, playing, and/or general lounging and sleeping.

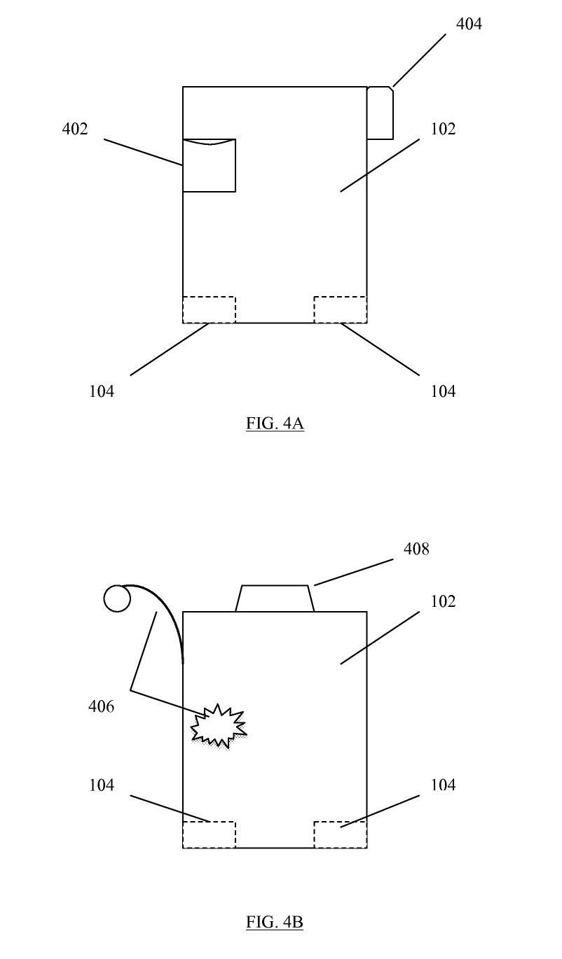

In some embodiments, as shown in FIG. 4A, the present device 100 can further comprise receptacles 402 for catnip or any other known and/or convenient feline attractant. In some embodiments, receptacles 402 can be positioned and removably attached to the posterior surface of a substantially planar member 102. However, in other embodiments, receptacles can be placed in any other known and/or convenient location on a substantially planar member 102, base member 104, or textured surface 106. In some embodiments, receptacles 402 can be removably attached to any of these components via hook-and-loop, snap fittings, adhesive, threading or any other known and/or convenient connection device. In other embodiments, catnip or other feline attractant can be integrated with, embedded into, or otherwise incorporated into a textured surface 106, a substantially planar member 102, or a base member 104. Moreover, a device 100 can further comprise a storage container 404 that can be used to store cat treats or any other desired object or substance. A storage container 404 can be coupled with a side edge of a substantially planar member 102, as shown in FIG. 4A, but in other embodiments a storage container 404 can be coupled with any other desired part of a device 100. A storage container 404 can be coupled with a device 100 via hook and loop, snap fittings, adhesive, threading, or any other known and/or convenient material or combination of materials. In some embodiments, a storage container 404 can be adapted to accept a standard cat food or cat treat receptacle.

Referring to FIG. 4B, a device 100 can further comprise at least one toy 406. A toy 406 can be a flexible hanging device, but in other embodiments a toy 406 can be stationary, flush with the surface of a substantially planar member 102, or can have any other position, configuration, geometry, or material composition. Moreover, a toy 406 can be removable, replaceable, and/or washable. Furthermore, in some embodiments, a device 100 can comprise a handle member 408 coupled with or integrated into a substantially planar member 102. A handle member 408 can enable a user to conveniently carry around a device 100.

In use, the present device can be installed proximate to an open or closed door. A user can position at least one base member 104 under a door such that the device can be secured in place via a friction fit. A substantially planar member 102 can then be in a substantially vertical position substantially parallel to the surface of a door and in a convenient location to be reached by a cat passing by. A cat can then rub against and/or scratch a textured surface 106, and/or play with one or more toys 406. If desired, the device can be easily removed from the base of the door. In some embodiments, at least one base member 104 can be folded against a substantially planar member 102 via a hinge mechanism 202, or at least one base member 104 can be selectively removed from a device 100, and a device 100 can be stowed away in a closet, cabinet, under a bed, or in any other desired location.

Although the method has been described in conjunction with specific embodiments thereof, it is evident that many alternatives, modifications and variations will be apparent to those skilled in the art. Accordingly, the method as described and hereinafter claimed is intended to embrace all such alternatives, modifications and variations that fall within the spirit and broad scope of the appended claims.

What is claimed:

1. A feline grooming device comprising:
a substantially planar member having an anterior surface and a posterior surface;
at least one base member having a distal end and a proximal end, wherein the distal end of said at least one base member is coupled with the lower portion of the posterior surface of said substantially planar member, such that the base member extends substantially perpendicular from the posterior surface of and vertically supporting said substantially planar member; and
a textured surface located on the anterior surface of said substantially planar member.

2. The device of claim 1, wherein said at least one base member is coupled with said substantially planar member via adhesive.

3. The device of claim 1, wherein said at least one base member has a wedge geometry.

4. The device of claim 1, wherein the anterior surface of said substantially planar member is textured.

5. The device of claim 1, further comprising at least one feline attractant receptacle.

6. The device of claim 1, wherein at least one of said substantially planar member and said at least one base member is comprised of material chosen from the group consisting of: wood, metal, plastic, polymer, fabric, carpet, and sisal.
